(19) United States
(12) Patent Application Publication
(10) Pub. No.: US 2006/0116870 A1
(43) Pub. Date: Jun. 1, 2006

(54) Method for audio and image data compression

(76) Inventors: Chih-Ta Star Sung, Glonn (DE); Chih-Sheng Cheng, Taoyuan City (TW)

Correspondence Address: Chih-Ta Star Sung;BLD. 52. NO. 195, RM. 308, CHUNG HSING RD., SEC. 4, CHU TUNG TOWNSHIP,, HSINCHU COUNTY, 310, TW

(21) Appl. No.: 10/997,049

(22) Filed: Nov. 26, 2004

(51) Int. Cl. G10L 21/00

(52) U.S. Cl. 704/212

(57) ABSTRACT

The present invention provides method of image and audio data compression. Filtering and down sampling means are firstly applied to reduce data of samples. The selected data samples are firstly compressed by means of ADPCM. The error between the original and the ADPCM coded data stream are calculated and compared to at least one predetermined value to determine the means of correction. Discrete Cosine Transform is applied to compress error data between the original and the ADPCM coded data stream. The DCT coefficients of error are inserted into the ADPCM data stream for correction.

### BACKGROUND OF THE INVENTION

1. Field of Invention

The present invention relates to audio and image compression and, more specifically to a method of compressing and compensating the error between the original and the ADPCM coded data.

2. Description of Related Art

Taking the advantage of the semiconductor technology migration trend, the analog-to-digital (ADC) converter and the digital-to-analog converter (DAC) have driven the digitalized audio and speech to an increasing number of applications including the telephony, the Compact Disc (CD) music, . . . etc.

With its top audio quality, the CD music has become prevailingly popular since more than 20 years ago. For compatibility, most CDs adopt standard of sampling rate and bit per sample. The standard CD music format in CD called “Wave” format with its file name “*.WAV” is an audio with 16 bits per sample and supports 32K, 44.1K and 48K sampling rates.

For reducing the need of the density of the storage device and the time of transmission, compression technique plays important role in the past decade in many audio and speech applications. Compared to speech, the audio comprises much complex and wider range of frequency of sound data which makes compression in the time domain extremely challenging and hence some compression approaches have been applied to the compression of the audio sounds, which include AC3, from Dobby Laboratories Inc., MP3 and AAC from MPEG Audio compression standard and WMA, the Window Media Audio compression algorithm from Microsoft. These popular audio compression algorithms firstly convert the time domain waveforms into frequency domain before going through other compression procedures. Taking the advantage of the so called “Psycho-acoustic Model”, MP3, AAC and WMA have successfully achieved higher compression rate of about 10 times in audio compression without sacrificing much the audio quality.

To achieve good audio quality and maintaining high compression rate, the popular audio compression methods of above algorithm require quite a high amount of computing power for modeling the “Psycho-acoustic phenomenon” and make the VLSI implementation quite complex, costly and consume high power for proper operation.

A prior art compression algorithm, ADPCM, Adaptive Quantization Differential Pulse Coded Modulation means is commonly used in the compression of image, speech and audio with low complexity. Comparing to image and speech, the audio has much wider range of change and hence the ADPCM is inadequate in achieving high compression while keeping good audio quality in the mean time.

This invention is to overcome the issue of high computing power and hence reduces the cost of the audio compression requirements which method can also be applied to image, speech and other waveform based applications. Applying this invention of the image and audio data compression reduces data rate which results in the saving of power dissipation during the transferring data between through wired or wireless communication channels.

### SUMMARY OF THE INVENTION

The present invention is related to a method of the image and audio data compression, which simply reduces the image or audio data by a costly means in computing power. The present invention significantly improves the image and audio quality compared to the prior art of the ADPCM and significantly reduces the required computing power compared to other frequency domain based image or audio compression algorithms like the JPEG-LS, JBIG, MP3, AAC or WMA.
The present invention of the image and audio compression reduces the redundant data mainly by adopting the ADPCM, Adaptive Quantized Differential Pulse Coded Modulation and adding an “error correction” means.
The present invention of the image and audio compression applies a digital filtering and down sampling means to reduce the data amount of data samples before sending the selected samples to the ADPCM compression procedure.
According to an embodiment of this invention of the present invention of the image and audio compression, a group of samples are checked to the linearity, the higher degree of linearity, the more sample can be skipped while still maintaining good quality of image and audio samples.
According to an embodiment of this invention of the present invention of the image and audio compression, the error (or difference) between the ADPCM code and the original data is extracted, compressed and insert into the bit stream of the ADPCM code.
According to an embodiment of this invention of the present invention of the image and audio compression, a “DPCM, Differential Pulse Coded Modulation” compression algorithm is applied to reduce the data amount between adjacent pixels to achieve higher compression rate.
According to an embodiment of this invention of the present invention of the audio waveform compression, an “Error Correction” mechanism is applied to decide whether or not to compensate the error between the ADPCM code and the original data.
According to an embodiment of this invention of the present invention of the image and audio waveform compression, a certain amount of the data of error between the ADPCM code and the original data are clustered as a “Unit” of the error correction.
According to an embodiment of this invention of the present invention of the image and audio waveform compression, should the “Error Correction” is selected for a certain block of data samples, either a time domain “Direct Correction” or a “DCT+Quantization” frequency domain compression algorithm is applied to reduce the data amount of the error correction code between the ADPCM code and the original data.

It is to be understood that both the foregoing general description and the following detailed description are by examples, and are intended to provide further explanation of the invention as claimed.

### BRIEF DESCRIPTION OF THE DRAWINGS

FIG. 1A shows a figure of the prior art of the ADPCM compression algorithm and the corresponding ADPCM code.

FIG. 1B depicts the original data waveform and the re-constructed waveform decoded from the ADPCM code.

FIG. 2A depicts an example of the original waveform and the re-constructed waveform decoded from the ADPCM code.

FIG. 2B depicts the error between the original waveform and the re-constructed waveform decoded from the ADPCM code.

FIG. 3 depicts the flowchart of the error compensation procedure which includes a step of compressing the “Error” between the original data waveform and the re-constructed data waveform decoded from the ADPCM code.

FIG. 4 shows the flowchart of a higher compression means of error correction procedure which includes an additional steps filtering and down sampling of FIG. 3.

FIG. 5 illustrates the flow chart of the procedure of decision making of correcting the error between the original data waveform and the re-constructed data waveform decoded from the ADPCM code.

FIG. 6 illustrates the block based compression unit of the error between the original data waveform and the re-constructed data waveform decoded from the ADPCM code.

FIG. 7 illustrates the procedure of compressing the ADPCM error and the structure of the data stream with compressed code of the error correction bits.

FIG. 8 illustrates an example of a 1-dimentional DCT and the base function.

FIG. 9 illustrates the 1-D DCT coefficients and the quantized DCT coefficients.

FIG. 10 depicts the data waveform of the error and the folded 2D data forms for the 2-Dimentional DCT.

### DESCRIPTION OF THE PREFERRED EMBODIMENTS

The present invention relates specifically to the compression of the data waveform image, audio and speech data reduction while still maintaining good quality. The present invention significantly reduces the amount of image and audio data and stored in a storage device, and correspondingly reduce the density, bandwidth requirement and cost of storage devices for storing image and audio data.

In the foregoing general description, all terms mentioning “audio” in general stands for the inclusion but not limit to any forms of representative of “speech”, and “audio”.

In compressing the image and audio data, one can actually reduce the amount of data stored for reproduction by using a concept related to delta modulation as follows. When the image and audio data waveform is being sampled, for each sample a value is stored that represents the amplitude difference between samples. This scheme, called Differential Pulse-Code Modulation, or DPCM, allows more that a single bit of difference between stored samples, accommodating more variation in the input data before severe distortion sets in. The DPCM value can be expressed as a fraction of the allowed input range or the absolute difference between samples. DPCM exhibits some of the same limitations as the simple delta modulation but to a lesser degree. Only when the difference between samples is greater than the maximum, the DPCM encoding value with distortion (called a “compliance error”) occur. Then the only solution is to reduce the input bandwidth or raise the sampling frequency, the later reduce the magnitude of values between sampled image and audio data.

The breakthrough in the prior art digitized image and audio compression is the technique known as adaptive differential pulse-code modulation (ADPCM), a specialized form of DPCM that offers significantly improved intelligibility at lower data rate. This system was devised to overcome the defects of the delta-modulation techniques described thus far while still reducing the overall data rate and improving the output's compliance with the source waveform. The ADPCM improves upon DPCM by dynamically varying the quantization between samples depending upon their rate of change while maintaining a low bit rate, condensing a 16-bit PCM samples into only 3 or 4 bits. The variations in the quantization value are regulated with regard to the characteristic complex sine waves that occur in image and audio.

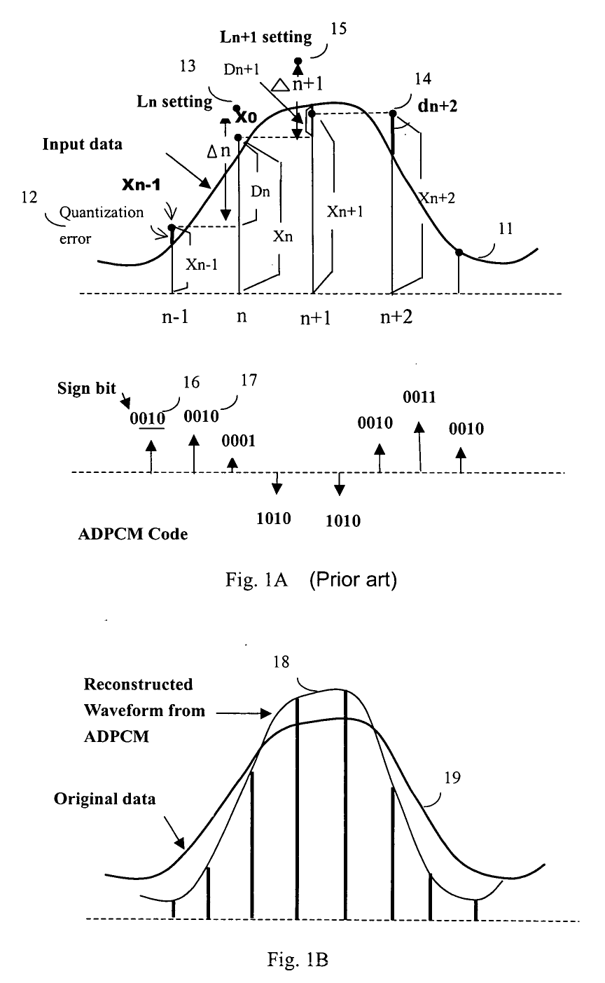

In ADPCM, each sample's encoding is derived by a complicated procedure that includes the following steps as shown in FIG. 1A:
Dn=Xn−Xn−1 Eq. (1)
Qn=Qn−1×M×(|Ln−1|) Eq.(2)
A PCM-value differential Dn 13 as show in Eq. (1) above is obtained by subtracting the previous PCM-code value from the current value; the quantization value, Qn is obtained by multiplying the previous quantization value, Qn−1, times a coefficient times the absolute value of the previous PCM-code value as details shown above in Eq. (2); the PCM-value differential is then expressed in terms of the quantized value and encoded in four bits (ex. 0010, 0011) 16, 17 with the 1^{st} bit as the sign bit, as shown in FIG. 1A. The ADPCM coded values can be reconstructed to be waveform 18 close to the original raw data 19 as shown in FIG. 1B. The error is mainly caused by the quantization is so named “Quantization Error” 14. It might be difficult to tell the quantization error if the sampled data of adjacent image and/or audio data are not abruptly changed. Which also means that the more smooth (or the higher the linearity), the smaller the quantization error will be. One of the benefit of the ADPCM is the quantization error can be pull back to a minimum value once the current ADPCM code shows significant error, it takes opposed direction of quantization to correct the error of the previous sampled data.

No matter how quickly the ADPCM can correct itself the error, it is easy to tell the error caused by quantization of especially high frequency samples or abrupt change of samples. This invention of the waveform audio compression is based on the ADPCM plus an “Error correction” mechanism to compensate the error hence to provide better image and audio quality.

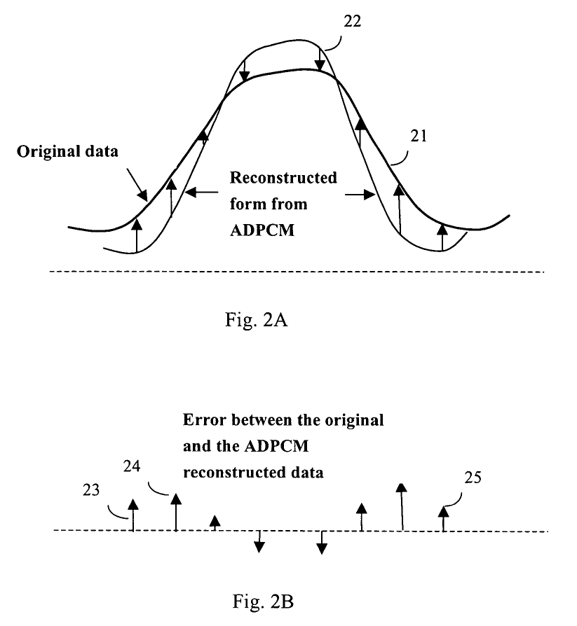

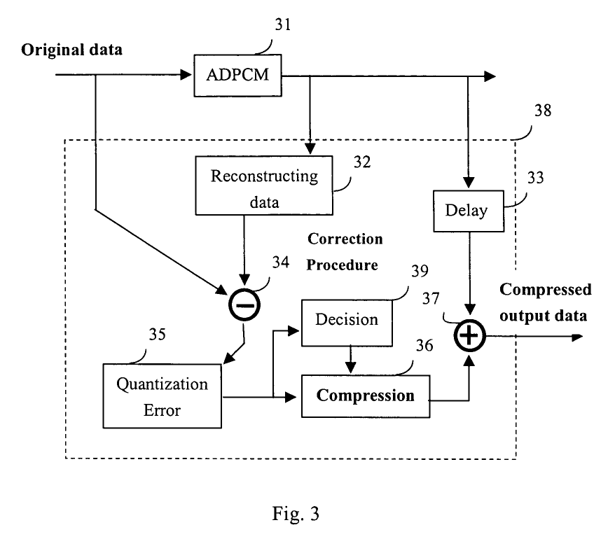

FIG. 2A depicts the original waveform 21 of the image and audio data and the reconstructed data waveform 22 derived from the ADPCM code. The error 23, 24 of each samples caused mainly by the quantization are shown in FIG. 2B. The block diagram of the procedure of this invention of the image and audio compression is shown in FIG. 3. An ADPCM compression procedure 31 is the first step applied to reduce the amount of the image and audio data. The ADPCM code is fed into the reconstructing block 32 is to recover the image and audio waveform of the ADPCM codes. A subtract 34 is applied to generate the difference between the original and the ADPCM reconstructed waveforms. A storage device 35 is implemented to temporarily save the difference or in reality, so named the “Quantization Error”. A compression procedure 36 is taken to reduce the amount of data of the “Quantization Error”. For coding efficiency, a certain amount of samples of image and audio is clustered as a compression unit so called “block”. A procedure of decision making 39 takes the quantization error for analysis and decide that whether the present block of the quantization error needs to be corrected or not.

Once the decision is made, the signal instructs the compression procedure block 36. The ADPCM code will hence be delayed 47 before it is mixed 49 with the compressed error correction code.

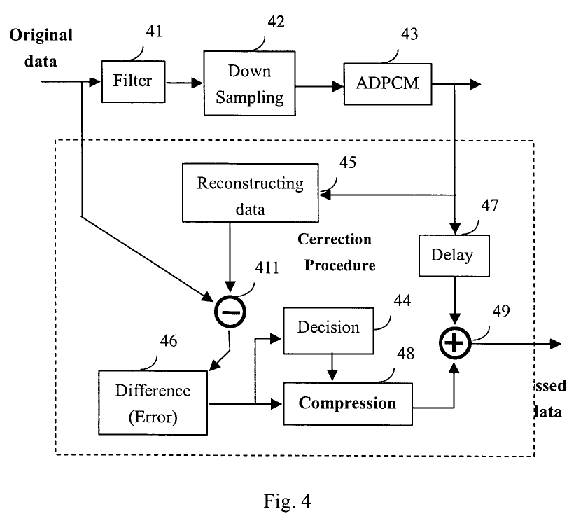

In another image and audio applications with higher compression rate, the present invention of the image and audio compression adds two preprocessing steps of “Filtering” 41 and “Down Sampling” 42 as shown in FIG. 4. A filter adopted in this present invention is a “Low Pass” filter used to get rid of the high frequency noise. A down sampling step is to eliminate data samples. For example, a 2:1 down sampling rate mechanism is to through away every other sample within an image and audio data stream. During down sampling, a group of a certain amount of pixels will be checked to see the degree of linearity. The higher degree of linearity, the more sample can be skipped. From the other hand, when the data stream change more abruptly, more frequently the samples will be selected to avoid data loss in the procedure of down sampling. To avoid causing noise caused by the down sampling, the filtering step is needed preliminarily for making image and audio data smooth. Other procedures of the image and audio compression of achieving higher compression rate is similar to procedures described above which including a reconstructing 45 loop, a subtract 411, a storage device 46 for temporarily saving the quantization error, a decision making 44, compression mechanism 48 and a mixer 49 to combine the ADPCM code and the compressed error code.

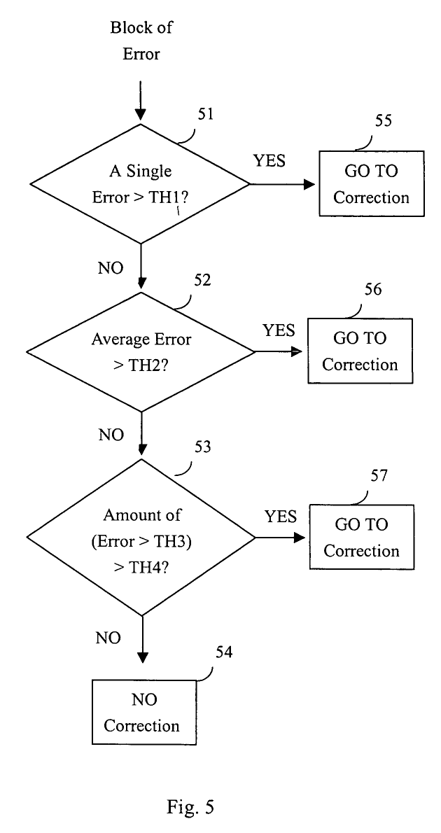

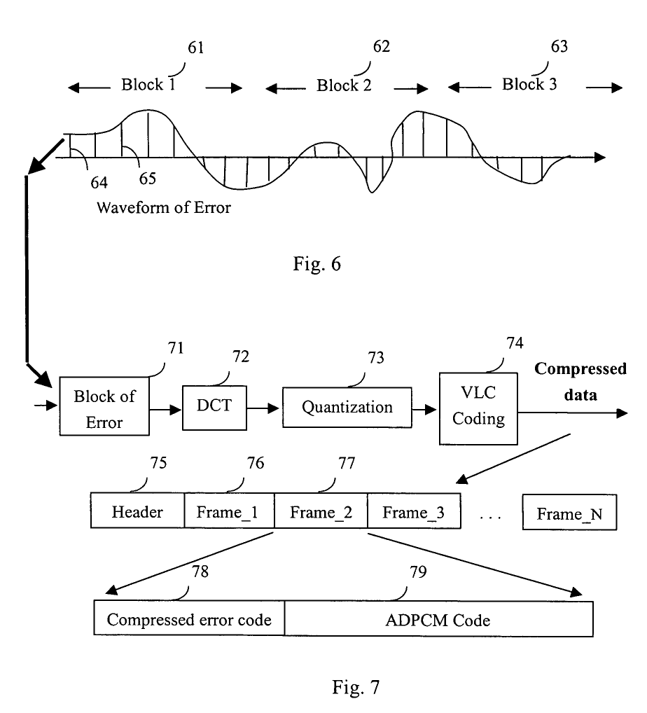

For code efficiency, a group of sequential errors are clustered as a compression unit so hereby named “Block of error” 61, 62, 63 as shown in FIG. 6. FIG. 5 illustrates the flow chart of the decision making (44 in FIGS. 4 and 39 in FIG. 3) of the data waveform error correction and compression of the correction code. The block of error is checked and compared to TH1, a predetermined threshold value to determine whether any single error data is greater that than TH1 or not 51, if the answer is YES, then, then the error code is going to be compensated and gone through a correction-compression procedure 55. If no single error greater than TH1, then, the average of the block of error is compared to TH2, another predetermined threshold value to determine whether the average of the block of error is greater than TH2 or not 52. If YES, then the error code is going to be compensated and to go through a correction-compression procedure 56.

If the average of error is less than TH2, then, the amount of error which is greater than TH3 so name No-err, is compared to TH4, another predetermined threshold, if No-err is greater than TH4, then, the error code is going to be compensated and to go through a correction-compression procedure 57. The decision making procedure helps in waiving the procedure and code of the error correction should it decides that a block of error is unnecessary and can be negligible.

Once the decision making procedure decides to make an error correction, in this invention, if the average of error is within a predetermine range said from TH4 to TH5, the errors can be rounded to the closest predetermined values, those errors greater TH5 are copied to be recovered to be original values. If most error are within a predetermined range, said TH4 to TH6, a DCT, Discrete Cosine Transform algorithm mechanism 72 followed by the procedure of quantization 73 is applied to compress the block of errors. A VLC 74, Variable Length Coding technique is applied to reduce the length of code. One of the most popular VCL coding is the Huffman coding which uses the shortest code to represent the most frequent show-up pattern hence reduces the length of code. The compressed error correction code 78 is inserted into the head of the ADPCM code 79 as shown in FIG. 7 to form a “Frame” of the compressed data stream. A sequence of the compressed data is comprised of an image or audio header 75 and a certain amount of “Frames” 76, 77 of image or audio data.

$$F ( i , j ) = \frac{1}{\sqrt{2 N}} C ( u ) {\sum }_{u = 0}^{7} f ( x ) cos \frac{( 2 x + 1 ) u π}{2 N} \qquad Eq . ( 3 )$$

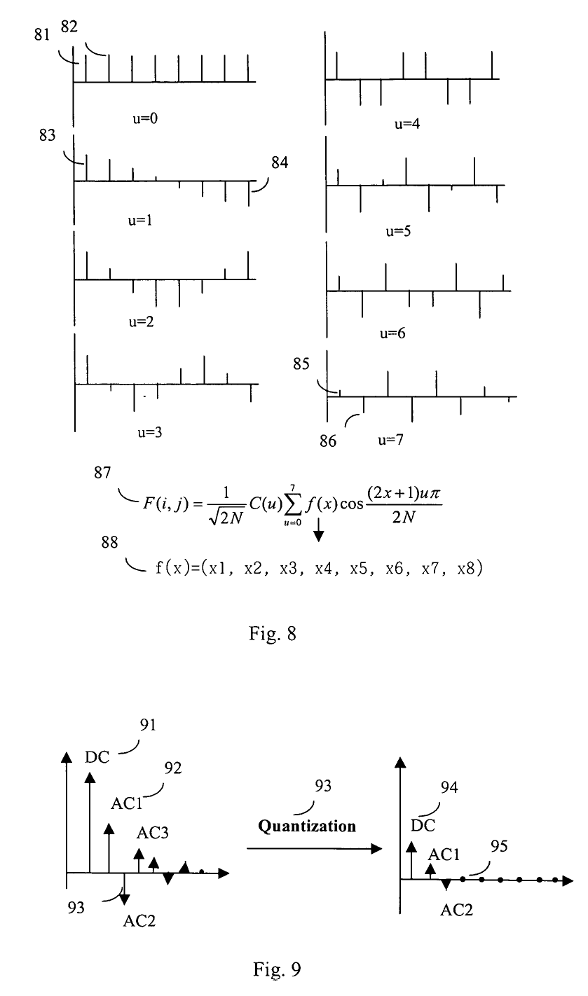

f(x)=(x1,x2,x3,x4,x5,x6,x7,x8) Eq. (4)
Eq. (3) shows an equation of an example of a 8-point DCT, Discrete Cosine Transform. Eq. (4) is the 8 samples of input data. DCT converts the time domain data into frequency domain and the information naturally concentrated in the left DCT coefficients. FIG. 8 shows the 1-dimentional “Base Functions” for 8-point input DCT conversion. Input of the 8 samples is multiplied by the 8 values 81, 82 of each Base Function to form the DCT coefficient. The higher frequency, the more variable 83, 84, 85, 86 the base function. After DCT conversion, the farer from the left corner of the DCT coefficient, the higher frequency the DCT coefficient are and which dominate less information. An example of the 8-point DCT coefficient is shown in FIG. 9. The first coefficient 91 is named “DC Coefficient”, the following one 92 is named “AC1 coefficient” and “AC2” as the next coefficient. A quantization procedure 93 filters out those higher frequency coefficients and makes more 0s 95 in AC coefficients which therefore make shorter length of code easier.

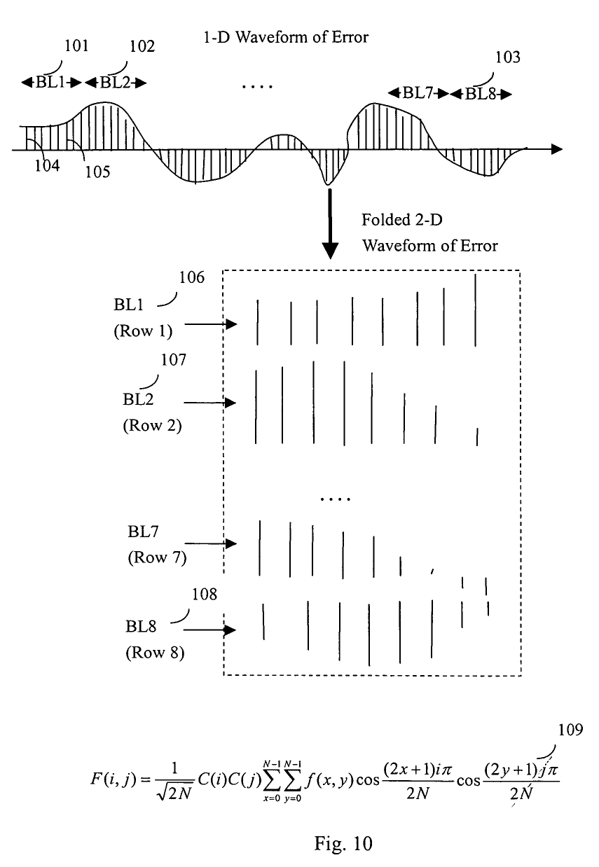

In applying DCT compression technique, theoretically it is correct that more data together in compressing, the higher efficiency in compression. In this invention of the image and audio compression of the error correction, a 2-Dimentional compression skill is applied to further compress the error data since there will be no correlation between error code not only in the X-axis, but also in the Y-axis. So, a group of continuous error data can be segmented into for example 8-point as a row of error data. Eq. (5) describes a 2-D DCT equation of the 8×8 points samples. FIG. 10 depicts an example of how the 64 samples of error forms an 8×8 block of error data.

$$F ( i , j ) = \frac{1}{\sqrt{2 N}} C ( i ) C ( j ) {\sum }_{x = 0}^{N - 1} {\sum }_{y = 0}^{N - 1} f ( x , y ) cos \frac{( 2 x + 1 ) i π}{2 N} cos \frac{( 2 y + 1 ) j π}{2 N} \qquad Eq . ( 5 )$$

The errors can be clustered into 1-D “Block” as seen in “BL1”, “BL2”, . . . “BL7” “BL8” 102, 102, 103, which including error data 104, 105. Folding these 1-D “blocks of error” can form a 2-D “Blocks of 8×8 Errors” with BL1 deemed as “Row 1” 106, BL2 deemed as “Row 2” 106, and BL8 deemed as “Row 8” 108. The DCT transform is of course much complex than the 1-D DCT transform, but the coding efficiency with the same resolution will be higher than the 1-D DCT. In the present invention of the image and audio compression, a 2-D DCT for error data compression is selected in the application which requires higher compression rate with competitive quality.

For pursuing even higher compression rate of the error code, a 3-D DCT is selected. The longer stream of error data like 512 samples can be folded to form an 3-D cube of 8×8×8. A 3-D DCT can be applied to compress these 3-D error data cube with faster transform and high compression rate.

Another VLC coding technique is also an alternative applying to compress the error between the original and the ADPCM coded data streams. This method of coding is to code the “R, remainder”, a “K” of the 2ˆˆK representing “M, divider” and “Q, quotient” as shown in the following equation:
V=Q×M+R
(Q: Quotient, M: divider and R: Remainder)
The error code of the original and ADPCM coded data streams has high linearity. Therefore, the M (Divider) and Q (Quotient) have high degree of predictability. Based on the principle of high continuity of either adjacent image or audio sample, the M and Q of current sample can be predicted and needs no individual code to represent these two parameters and therefore, the only data left for coding is the R (Remainder).

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for compressing a data stream, comprising:
temporarily saving at least one data sample into a storage device;
applying an ADPCM, Adaptive Differential Pulse Coded Modulation method to firstly reduce the amount of the data stream;
calculating the error between the original and the ADPCM coded data stream; and
asserting code of correction into the ADPCM coded data stream.

2. The method of claim 1, wherein the plurality of the error between the original and the ADPCM coded data stream is calculated and compared to predetermined threshold values to decide means of how to correct the error.

3. The method of claim 2, wherein when the magnitude of error of a single sample is beyond a predetermined value, the procedure of error correction is applied to minimize the error.

4. The method of claim 2, wherein if the average of error between the original and the ADPCM coded data stream is beyond another predetermined value, the procedure of error correction is applied to minimize the error.

5. The method of claim 2, wherein when the amount of sample having error beyond a predetermined value is beyond another predetermined value, the procedure of error correction is applied to minimize the error.

6. The method of claim 1, wherein the error between the original and the ADPCM coded data stream is compressed.

7. The method of claim 1, wherein the error between the original and the ADPCM coded data stream is coded by applying a variable length code of a remainder, a predicted divider and a predicted quotient.

8. The method of claim 1, wherein the plurality of the data stream comprises image data stream.

9. The method of claim 1, wherein the plurality of the data stream comprises audio data stream.

10. A method for compressing a data stream, comprising:
temporarily saving at least one data sample into a storage device;
applying a filtering method to firstly filter out higher frequency information;
down sampling the data stream by not selecting all samples;
coding the selected samples with ADPCM means;
calculating the error between the original and the ADPCM coded data stream; and
asserting code of correction to minimize the error of the ADPCM coded data stream.

11. The method of claim 10, wherein in down sampling, if a group of samples shows less linearity, more samples will be selected.

12. The method of claim 10, wherein in down sampling, if a group of samples shows high linearity, less samples will be selected.

13. The method of claim 10, wherein in down sampling, if a group of samples shows high linearity, less samples will be selected.

14. The method of claim 10, wherein the plurality of the error between the original and the ADPCM coded data stream is calculated and compared to predetermined threshold values to decide means of how to correct the error.

15. A method for compressing a data stream, comprising:
applying an ADPCM, Adaptive Differential Pulse Coded Modulation method to firstly reduce the amount of the data stream;
Compressing the data of error between the original and the ADPCM coded data stream by means of DCT, Discrete Cosine Transform; and
asserting correction data of DCT coefficients into the ADPCM coded data stream.

16. The method of claim 15, wherein the plurality of the error between the original and the ADPCM coded data stream is calculated and compressed by means of 1-D DCT.

17. The method of claim 15, wherein the plurality of the error between the original and the ADPCM coded data stream is calculated and compressed by means of 2-D DCT.

18. The method of claim 15, wherein the plurality of the error between the original and the ADPCM coded data stream is calculated and compressed by means of 3-D DCT.

19. The method of claim 17, wherein the plurality of stream of error data between the original and the ADPCM coded data stream are folded to form a 2-D matrix of error data for the 2-D DCT transform.

20. The method of claim 18, wherein the plurality of stream of error data between the original and the ADPCM coded data stream are folded to form a 2-D matrix of error data for the 3-D DCT transform.
